(19) United States
(12) Patent Application Publication
(10) Pub. No.: US 2017/0153962 A1
(43) Pub. Date: Jun. 1, 2017

(54) MONITORING THE PERFORMANCE OF THREADED APPLICATIONS

(71) Applicant: International Business Machines Corporation, Armonk, NY (US)

(72) Inventors: Arkadiusz W. Biegun, Wola Radziszowska (PL); Tomasz D. Chmielecki, Krakow (PL); Bartlomiej T. Malecki, Slomniki (PL); Konrad K. Skibski, Zielonki (PL)

(21) Appl. No.: 14/953,998

(22) Filed: Nov. 30, 2015

(51) Int. Cl. G06F 11/34; G06F 11/30; G06F 9/46

(52) U.S. Cl. CPC G06F 11/3409; G06F 9/46; G06F 11/3024

(57) ABSTRACT

An ability to monitor the performance of a threaded application is provided. A thread that is executing is detected, wherein the thread is spawned by a threaded application. A thread class of the thread is determined. A performance metric of the thread is measured. A trend that describes a consumption of the performance metric as a function of percent execution time is interpolated. In response to determining that a threshold associated with the performance metric is exceeded based on a comparison of the trend to a trend template that is associated with the performance metric, an alert is issued. The alert identifies the thread as an abnormally executed thread in order to trigger a corrective action that improves a performance of a computing device that is configured to execute the threaded application.

### TECHNICAL FIELD

The present invention relates generally to the field of diagnostic software and, more particularly, to diagnostic software for monitoring the performance of threaded applications.

### BACKGROUND

In computer science, a thread of execution is the smallest sequence of programmed instructions that can be managed independently by a scheduler, which can be a part of an operating system. The implementation of threads and processes differs between operating systems. In general, a thread is a component of a process. Multiple threads can exist within the same process, executing concurrently and share resources such as memory, while different processes do not share these resources. In particular, the threads of a process can share instructions (i.e., executable code) and contexts (i.e., the values of its variables at any given moment). The threaded programming model provides developers with a useful abstraction of concurrent execution. Multithreading can also be applied to a single process to enable parallel execution on a multiprocessing system.

On a single processor, multithreading is generally implemented by time slicing (as in multitasking), and the central processing unit (CPU) switches between different software threads. This context switching generally happens frequently enough that the user perceives the threads or tasks as running at the same time (i.e., in parallel). On a multiprocessor or multi-core system, multiple threads can be executed in parallel (i.e., at the same instant), with every processor or core executing a separate thread simultaneously; on a processor or core with hardware threads, separate software threads can also be executed concurrently by separate hardware threads.

### SUMMARY

According to one embodiment of the present invention, a first method is provided. The method includes: detecting, by one or more computer processors, a thread that is executing, wherein the thread is spawned by a threaded application; determining, by one or more computer processors, a thread class of the thread; measuring, by one or more computer processors, a performance metric of the thread based on the thread class; interpolating, by one or more computer processors, a trend that describes a consumption of the performance metric as a function of percent execution time; and in response to determining, by one or more computer processors, that a threshold associated with the performance metric is exceeded based on a comparison of the trend to a trend template that is associated with the performance metric, issuing, by one or more computer processors, an alert identifying the thread as an abnormally executed thread in order to trigger a corrective action that improves a performance of a computing device that is configured to execute the threaded application.

According to another embodiment of the present invention, a second method is provided. The method includes: detecting, by one or more computer processors, a thread that is executing, wherein the thread is spawned by a threaded application; determining, by one or more computer processors, a thread class of the thread; measuring, by one or more computer processors, a plurality of performance metrics of the thread based on the thread class; for each performance metric, interpolating, by one or more computer processors, a respective trend that describes a consumption of a respective performance metric as a function of percent execution time; for each performance metric, comparing, by one or more computer processors, the respective trend to a respective trend template; generating, by one or more computer processors, a composite value based on a plurality of trends and a plurality of trend templates; and in response to determining, by one or more computer processors, that the composite value exceeds every composite threshold value of a plurality of composite threshold values, issuing, by one or more computer processors, an alert identifying the thread as an abnormally executed thread in order to trigger a corrective action that improves a performance a computing device that is configured to execute the threaded application.

According to another embodiment of the present invention, a third method is provided. The method includes: detecting, by one or more computer processors, a thread that is executing; determining, by one or more computer processors, a thread class of the thread; measuring, by one or more computer processors, a plurality of performance metrics of the thread based on the thread class; for a first performance metric, calculating, by one or more computer processors, an interpolated trend that describes a consumption of the first performance metric as a function of percent execution time; in response to determining, by one or more computer processors, that a first trend template that is associated with the first performance metric is invalid, modifying, by one or more computer processors, the first trend template based on the interpolated trend, wherein the first trend template is one of a plurality of trend templates that includes a second trend template, and wherein the second trend template is associated with a second performance metric of the plurality of performance metrics; and in response to determining, by one or more computer processors, that each template of the plurality of trend templates is valid, modifying, by one or more computer processors, a composite threshold value based on the plurality of trends and the plurality of trend templates, wherein the composite threshold value is associated with the thread class.

According to another embodiment of the present invention, a computer program product is provided. The computer program product comprises a computer readable storage medium and program instructions stored on the computer readable storage medium. The program instructions include: program instructions to detect a thread that is executing, wherein the thread is spawned by a threaded application; program instructions to determine a thread class of the thread; program instructions to measure a performance metric of the thread based on the thread class; program instructions to interpolate a trend that describes a consumption of the performance metric as a function of percent execution time; and program instructions to, in response to determining that a threshold associated with the performance metric is exceeded based on a comparison of the trend to a trend template that is associated with the performance metric, issue an alert identifying the thread as an abnormally executed thread in order to trigger a corrective action that improves a performance of a computing device that is configured to execute the threaded application.

According to another embodiment of the present invention, a computer system is provided. The computer system includes one or more computer processors, one or more computer readable storage media, and program instructions stored on the computer readable storage media for execution by at least one of the one or more processors. The program instructions include: program instructions to detect a thread that is executing, wherein the thread is spawned by a threaded application; program instructions to determine a thread class of the thread; program instructions to measure a performance metric of the thread based on the thread class; program instructions to interpolate a trend that describes a consumption of the performance metric as a function of percent execution time; and program instructions to, in response to determining that a threshold associated with the performance metric is exceeded based on a comparison of the trend to a trend template that is associated with the performance metric, issue an alert identifying the thread as an abnormally executed thread in order to trigger a corrective action that improves a performance of the one or more computer processors, wherein the one or more computer processors are configured to execute the threaded application.

### BRIEF DESCRIPTION OF THE DRAWINGS

FIG. 1 is a functional block diagram illustrating a computing environment, in accordance with an embodiment of the present invention.

FIG. 2 is a block diagram of components of a computing device within the computing environment of FIG. 1, in accordance with an embodiment of the present invention.

FIGS. 3A-3D are flowcharts depicting operations for monitoring the performance of a threaded application on a computing device within the computing environment of FIG. 1, in accordance with various embodiments of the present invention.

FIG. 4 is a graph that depicts an example of a trend that is calculated from data describing consumption of a computing resource as a function of percent execution time, in accordance with an embodiment of the present invention.

FIGS. 5A-5C depict examples of comparisons between an interpolated trend and a trend template, in accordance with an embodiment of the present disclosure.

### DETAILED DESCRIPTION

Embodiments of the present invention recognize that is difficult to implement diagnostic software (e.g., health check mechanisms) in threaded applications. One issue is that the distribution of threads (i.e., the number and/or timing of threads) can vary greatly between deployments of a threaded application. Another issue is that relevant performance metrics can vary greatly between deployments of a threaded application. Yet another issue is minimizing the impact of the diagnostic software on the performance of the threaded application.

Embodiments of the present invention provide diagnostic software that includes health check mechanisms for measuring and analyzing various performance metric(s) of a threaded application. Some embodiments of the present invention also provide the ability to calculate one or more trend templates for various classes of threads (i.e., characterize the “baseline” behavior of various types of threads) based on the performance of a specific deployment of the threaded application. Some embodiment also provide the ability to detect progressive degradation of the performance of the threaded application over time. Additionally, embodiments of the present invention minimally impact performance of the threaded application. Embodiments of the present invention will now be described in detail with reference to the Figures.

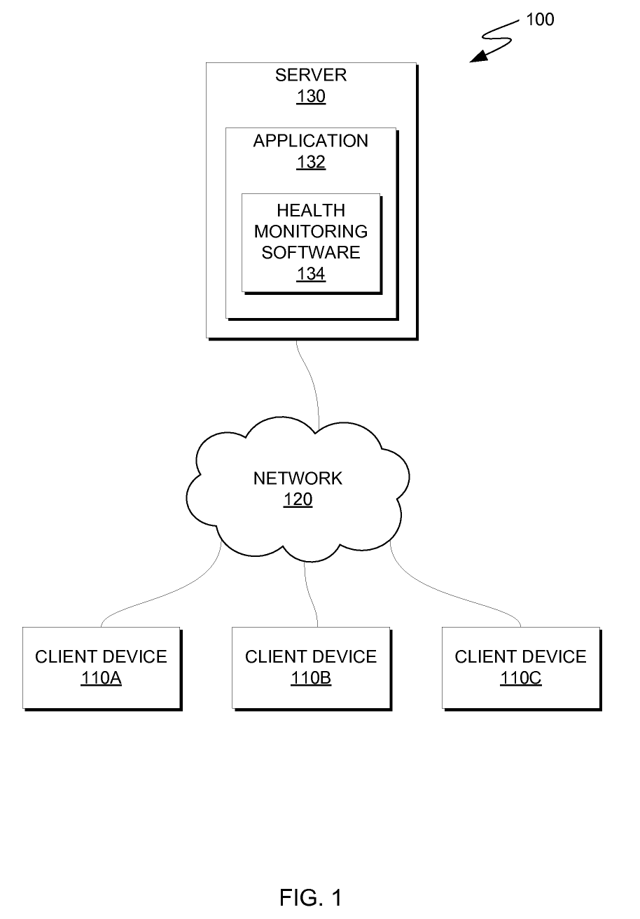

FIG. 1 is a functional block diagram illustrating a computing environment, in accordance with an embodiment of the present invention. For example, FIG. 1 is a functional block diagram illustrating computing environment 100. Computing environment 100 includes server 130, client device 110A, client device 110B, and client device 110C, all communicatively connected via network 120. Client devices 110A, 110B, and 110C are collectively referred to as client devices 110 herein. While the embodiment depicted in FIG. 1 includes three client devices that are communicatively connected to server 130, the number of client devices 110 to which server 130 can communicatively connect to at any one time is not a limitation of the present invention. Accordingly, server 130 can communicatively connect to a greater or lesser number of client devices 110 than are depicted in FIG. 1.

In various embodiments, each of client devices 110 is a computing device that can be a standalone device, a server, a laptop computer, a tablet computer, a netbook computer, a personal computer (PC), a desktop computer, a personal digital assistant (PDA), a smart phone, or another type of programmable electronic device. In some embodiments, client devices 110 are a collection of different types of computing devices. In other embodiments, each of client devices 110 represents a computing system utilizing clustered computers and components to act as a single pool of seamless resources. In general, each of client devices 110 can be any computing device or a combination of devices that is capable of transmitting various types of requests to server 130, as described herein.

Network 120 can be, for example, a local area network (LAN), a wide area network (WAN) such as the Internet, or a combination of the two, and may include wired, wireless, fiber optic or any other connection known in the art. In general, network 120 can be any combination of connections and protocols that will support communication between each of client devices 110 and server 130.

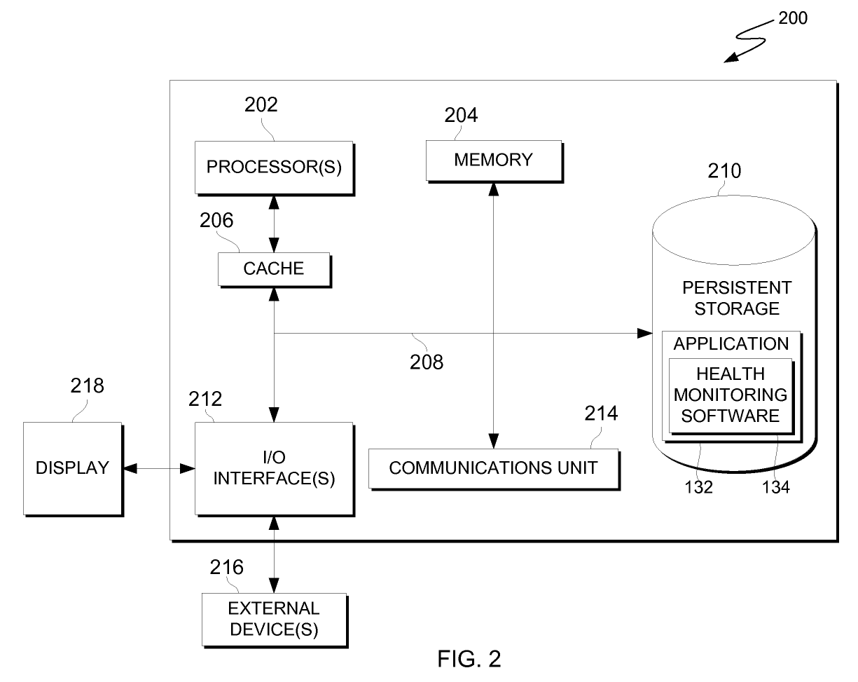

Server 130 is a computing device that can be a standalone device, a server, a laptop computer, a tablet computer, a netbook computer, a personal computer (PC), or a desktop computer. In some embodiments, server 130 represents a computing system utilizing clustered computers and components to act as a single pool of seamless resources. In general, server 130 can be any computing device or a combination of devices with access to and/or capable of executing applications 132 and health monitoring software 134 and provided that server 130 can access and is accessible by client devices 110. In the embodiment depicted in FIG. 1, application 132 and health monitoring software 134 reside on server 130. In other embodiments, one or more of application 132 and health monitoring software 134 can reside on various other computing devices, provided that each can provide the functionality described herein. In yet other embodiments, one or both of application 132 and health monitoring software 134 can be stored externally and accessed through a communication network, such as network 120. Server 130 can include internal and external hardware components, as depicted and described in further detail with respect to FIG. 2.

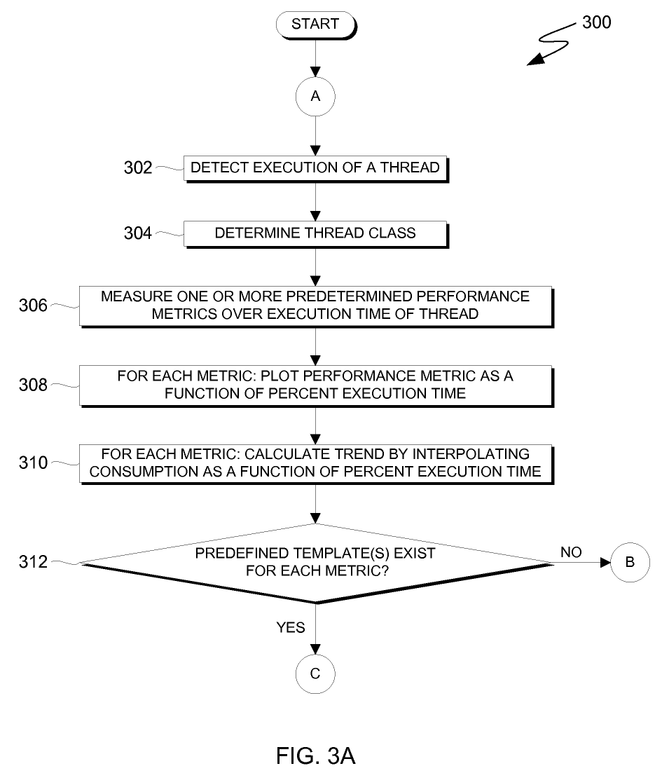

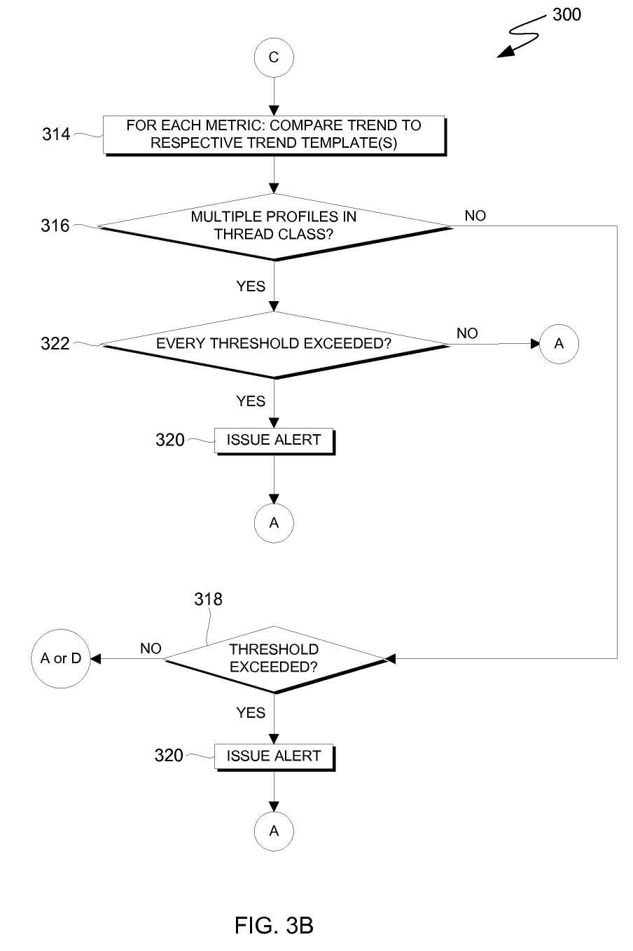

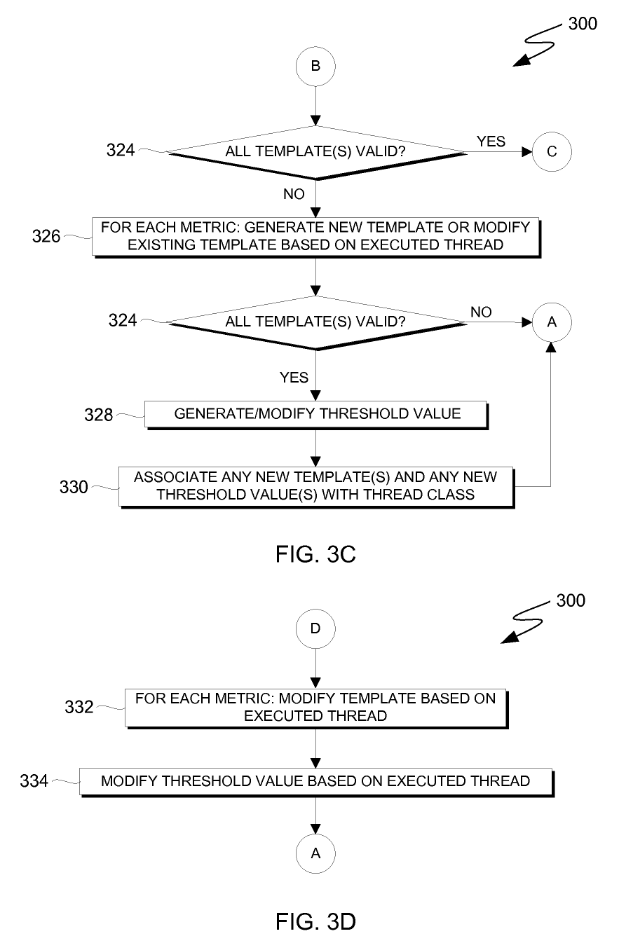

Application 132 is a threaded application that operates to service requests from client devices 110. In response to receiving a request from one of client devices 110, application 132 spawns one or more threads to service the request. For example, application 132 can create threads to add new data items to a database that is communicatively connected to server 130, retrieve a list of data items, retrieve information related to specific data item(s), edit information related to specific data item(s), generate various report, and/or provide various other services. Each type of request is handled by a respective thread class (i.e., each type of service/request is associated with a specific thread class). In general, the types of services that application 132 provides to client devices 110 is not a limitation of the present invention, unless noted otherwise (e.g., limitations as discussed with respect to FIGS. 3A-3D).

When executed on server 130, the thread classes consume computing resources (e.g., processor time, memory, and/or network bandwidth) to various degrees. As described in greater detail with respect to FIGS. 3A-3D, health monitoring software 134 operates to measure one or more performance metrics (i.e., the consumption of one or more computing resources), calculate a trend for each metric, and compare each trend to a respective trend template (i.e., a baseline of resource consumption associated with the a corresponding thread class). In some embodiments, application 132 or one or more thread classes are instrumented in order to measure various metrics. In other embodiments, the code of application 132 is modified to include the functionality described with respect to health monitoring software 134, and following modification, application 132 is recompiled. Health monitoring software 134 can perform various predefined actions when one or more performance thresholds are exceeded (e.g., generate a warning), as described herein.

FIG. 2 is a block diagram of components of a computing device within the computing environment of FIG. 1, generally designated computing system 200, in accordance with an embodiment of the present invention. In one embodiment, computing system 200 is representative of server 130 within computing environment 100, in which case computing system 200 includes application 132 and health monitoring software 134.

It should be appreciated that FIG. 2 provides only an illustration of one implementation and does not imply any limitations with regard to the environments in which different embodiments may be implemented. Many modifications to the depicted environment may be made.

Computing system 200 includes processor(s) 202, cache 206, memory 204, persistent storage 210, input/output (I/O) interface(s) 212, communications unit 214, and communications fabric 208. Communications fabric 208 provides communications between cache 206, memory 204, persistent storage 210, communications unit 214, and input/output (I/O) interface(s) 212. Communications fabric 208 can be implemented with any architecture designed for passing data and/or control information between processors (such as microprocessors, communications and network processors, etc.), system memory, peripheral devices, and any other hardware components within a system. For example, communications fabric 208 can be implemented with one or more buses or a crossbar switch.

Memory 204 and persistent storage 210 are computer readable storage media. In this embodiment, memory 204 includes random access memory (RAM). In general, memory 204 can include any suitable volatile or non-volatile computer readable storage media. Cache 206 is a fast memory that enhances the performance of processor(s) 202 by holding recently accessed data, and data near recently accessed data, from memory 204.

Program instructions and data used to practice embodiments of the present invention may be stored in persistent storage 210 and in memory 204 for execution by one or more of the respective processor(s) 202 via cache 206. In FIG. 2, for example, application 132 and health monitoring software 134 are stored in persistent storage 210. In an embodiment, persistent storage 210 includes a magnetic hard disk drive. Alternatively, or in addition to a magnetic hard disk drive, persistent storage 210 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer readable storage medium that is also part of persistent storage 210.

Communications unit 214, in these examples, provides for communications with other data processing systems or devices. In these examples, communications unit 214 includes one or more network interface cards. Communications unit 214 may provide communications through the use of either or both physical and wireless communications links. Program instructions and data used to practice embodiments of the present invention may be downloaded to persistent storage 210 through communications unit 214.

I/O interface(s) 212 allows for input and output of data with other devices that may be connected to computer system 200. For example, I/O interface(s) 212 may provide a connection to external device(s) 216 such as a keyboard, keypad, a touch screen, and/or some other suitable input device. External device(s) 216 can also include portable computer readable storage media such as, for example, thumb drives, portable optical or magnetic disks, and memory cards. Software and data used to practice embodiments of the present invention can be stored on such portable computer readable storage media and can be loaded onto persistent storage 210 via I/O interface(s) 212. I/O interface(s) 212 also connect to display 218.

Display 218 provides a mechanism to display or present data to a user and may be, for example, a computer monitor.

FIGS. 3A-3D are flowcharts depicting operations for monitoring the performance of a threaded application on a computing device within the computing environment of FIG. 1, in accordance with various embodiments of the present invention. For example, FIG. 3A is a flowchart depicting operations 300 of health monitoring software 134 on server 130 within computing environment 100.

In operation 302, health monitoring software 134 detects the execution of a thread spawned by application 132. In general, application 132 includes code that defines a plurality of thread classes, and each thread class is associated with one type of service that application 132 provides in response to receiving a respective request from one of client devices 110. Persons of ordinary skill in the art will understand that different services will utilize various computing resources to different degrees and in different proportions. Accordingly, the various thread classes will differ in terms of average resource consumption over time. In operation 304, health monitoring software 134 determines the thread class of the executing thread. In some embodiments, the thread self-identifies its class via meta-data. Health monitoring software 134 reads the meta-data to identify the thread-class of the executing thread. In other embodiments, health monitoring software 134 detects the execution of thread (operation 302) in response to receiving, from application 132, instructions to monitor the executing thread. In such embodiments, the instructions can identify the thread class of the executing thread. While the thread executes, health monitoring software 134 measures one or more predetermined performance metrics based on the thread class of the executing thread (operation 306). In some embodiments, the code of health monitoring software 134 associates specific performance metric(s) with respective thread classes. In other embodiments, health monitoring software 134 queries a database (e.g., a database residing on persistent storage 210) for performance metric(s) that are associated with the thread class of the executing thread.

In various embodiments, health monitoring software 134 measures relevant performance metric(s) at regular interval(s). In some embodiments, the length of the intervals is predefined for each thread class. In other embodiments, the length of the intervals is dynamically determined for each thread class based on data describing previously executed threads of the respective thread class (e.g., an average duration based on data describing the durations of previously executed threads). In yet other embodiments, a predetermined length of each interval can be modified based on data describing previously executed threads of the respective thread class in order to optimize health monitoring software 134 over time. In general, the length of the intervals between performance metric measurements for each thread class should be selected such that the interpolated trends(s), as described herein, are accurate approximations of the trend(s) described by the measured performance metric(s). While health monitoring software 134 can utilize actual time to determine when to measure relevant performance metric(s), it is advantageous to measure the relevant performance metric(s) based on the time in which the thread is executing on, for example, processor(s) 202 of server 130 (i.e., the execution time or CPU time). One benefit of measuring the relevant performance metric(s) based on execution time is a reduction of noise caused by processor(s) 202 switching contexts while the thread is “executing” (i.e., prior to completion of the thread).

After completion of the thread, health monitoring software 134 plots each performance metric as a function of percent execution time (operation 308). Embodiments of the present invention analyze the executed thread after completion of the thread. Consequently, health monitoring software 134 cannot be used to provide additional insights containing anything local to the executed thread when reporting the problem. For example, health monitoring software 134 cannot provide insights as to the states of variables, the states of registries, and/or other volatile properties that are allocated or exist only during execution of the thread. Stated differently, health monitoring software 134 cannot cause application 132 to generate a memory dump in response to health monitoring software 134 detecting a problem in situations where the thread has freed all of the resources that were allocated to the thread. Instead, health monitoring software 134 provides insights with regard to the measure performance metrics. In analyzing the thread after completion, however, server 130 does not need to allocate resources from the executing thread to health monitoring software 134. In general, the overhead of measuring the performance metric(s) is negligible. Therefore, the impact of health monitoring software 134 on the performance of application 132 is minimized by analyzing the thread after the thread has finished.

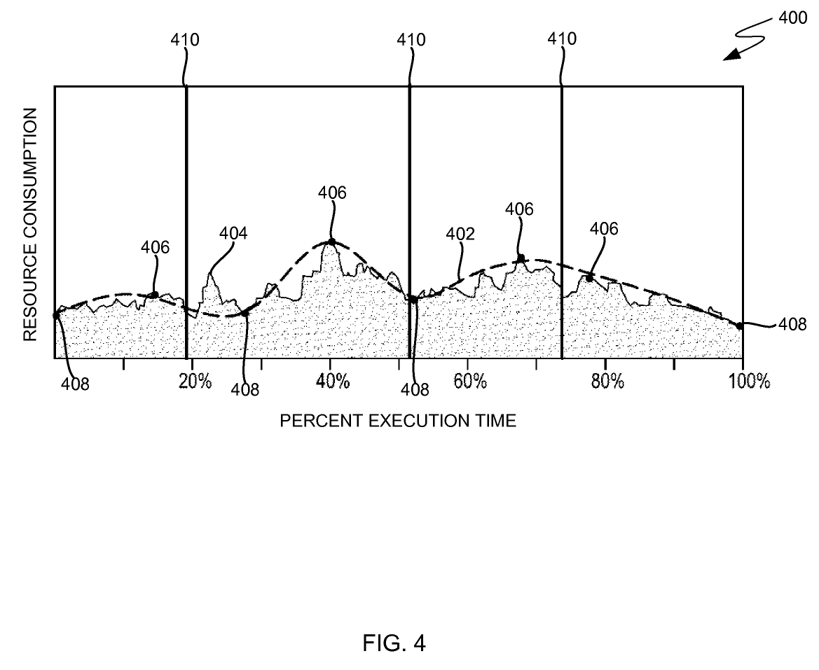

For each performance metric, health monitoring software 134 calculates a trend by, at least in part, interpolating the plot of a respective performance metric as a function percent execution time (operation 310). Interpolation of the trend for each measured performance metric is discussed in greater detail with respect to FIG. 4. If health monitoring software 134 determines that at least one predefined template exists for each measured performance metric (decision 312, YES branch), health monitoring software 134 performs operation 314. If health monitoring software 134 determines that at least one predefined trend template does not exist for each measured performance metric (decision 312, NO branch), health monitoring software 134 performs operation 324.

Decision 312 and the operations depicted in FIGS. 3B-3D described three types of embodiments of health monitoring software 134. In general, the three types of embodiments differ in whether or not predefined trend template(s) exist for the thread class of the executed thread and/or whether or not health monitoring software 134 can create and/or modify trend template(s). Person of ordinary skill in the art will understand that embodiments of the present invention can omit decision 312. Decision 312 is included in FIG. 3A to illustrate, at least in part, common characteristics (e.g., operations 302-310) and differences between the types of embodiments depicted in FIGS. 3B-3D.

FIG. 3B depicts additional operations of operations 300, in accordance with various embodiments of the present invention. For each measured performance metric, health monitoring software 134 compares the interpolated trend (i.e., the result of operation 310) to the trend template(s) associated with the performance metric. In some embodiments, the trend template is based on a predefined trend template. In other embodiments, the trend template is a valid trend template based on previously executed threads of the same thread class as the executed thread, as discussed in greater detail with respect to FIG. 3C. If a plurality of interpolated trends are compared to respective trend templates, health monitoring software 134 generates, in operation 314, a composite value that health monitoring software 134 can compare to a composite threshold value, as described in greater detail with respect to decisions 318 and 322. Stated differently, generating the composite value is analogous to generating a composite threshold value, as described with respect to operation 328.

It is advantageous to characterize each executing thread with respect to multiple performance metrics (i.e., analyze the behavior of an executed thread from different “angles”). For example, analyzing the performance of executed threads of the same thread class using multiple performance metrics can reduce the frequency of false positives (e.g., abnormally high resource consumption) compared to using a single performance metric. In embodiments where one or more thread classes are associated with multiple performance metrics, one or more thread profiles are associated with such thread classes. In some embodiments, a single thread profile is associated with each such thread class. In other embodiments, a plurality of thread profiles are associated with one or more such thread classes. In general, each thread profile of a plurality of thread profiles represents a different logical path (e.g., a first thread executes code following a first logical path based on a decision and a second thread executes code following a second logical path based on the decision). Stated differently, a thread class that is described by code including one or more conditional statements can be associated with a plurality of thread profiles. Because the logical paths of a thread class can differ significantly, complimentary trend templates (e.g., trend templates associated with logical paths representing outcomes of a conditional statement) associated with the same performance metric but different thread profiles can differ significantly as well.

If health monitoring software 134 determines that a single thread profile or a single trend template is associated with the thread class of the executed thread (decision 316, NO branch), health monitoring software 134 determines whether or not a respective threshold value is exceeded (decision 318). In embodiments where the thread class is associated with a single trend template, the threshold represents a distance between a baseline trend and a theoretical trend representing abnormal resource consumption. In such embodiments, the threshold value is compared to a distance between the interpolated trend and a trend template. In embodiments where the thread class is associated with a single thread profile, the threshold is a composite threshold value based on the trend templates that are associated with the thread class. In one type of embodiment, a composite threshold value can be a sum of constituent threshold values associated with respective performance metrics, each constituent threshold value representing a threshold distance between a baseline trend and a respective, theoretical trend representing abnormal resource consumption. In such types of embodiments, the composite threshold value is compared to a sum of distances between interpolated trends and respective trend templates in decision 318. In another type of embodiment, the composite threshold value represents an average distance between baseline trends and respective, theoretical trends representing abnormal resource consumption. In such types of embodiments, the composite threshold value is compared to an average distance based on distances between interpolated trends and respective trend templates in decision 318. Determining a distance between an interpolated trend and a trend template is discussed in greater detail with respect to FIG. 4.

If health monitoring software 134 determines that a threshold value is exceeded (decision 318, YES branch), health monitoring software 134 issues an alert that identifies the executed thread as an abnormally executed thread (operation 320). Issuing an alert can include generating a warning message that identifies the executed thread (e.g., by an identifying number that is associated with the thread, a date and/or time at which the thread was initiated/completed, or by another form of identification), generating a log of events that identifies the executed thread and describes event(s) relating to the executed thread, performing another action to warn a user of server 130 (e.g., a user of one of client devices 110 or an administrator of server 130), and/or performing another action to collect information related to the executed thread and/or subsequently executed threads of the same thread class as the executed thread. Based on the alert, a user of server 130 can take corrective action to, for example, prevent threads that are associated with the thread class of the executed thread from executing in the future or restore normal functionality to such threads. If health monitoring software 134 determines that a threshold value is not exceeded (decision 318, NO branch), health monitoring software (i) performs operation 332 if health monitoring software 134 can modify the trend template(s) or (ii) completes analyses of concurrently executing threads (i.e., concurrently executing instance(s) of operations 300 with respect to different thread(s)) and/or enters an idle state until another request is received from one of client devices 110 (i.e., until performing operation 302) or application 132 is exited.

If health monitoring software 134 determines that multiple thread profiles are associated with the thread class of the executed thread (decision 316, YES branch), health monitoring software 134 determines whether or not every threshold value associated with the thread profiles is exceeded (decision 322). Decision 322 is analogous to performing decision 318 for each thread profile. If health monitoring software 134 determines that not every threshold value is exceeded (i.e., that at least one thread profile validates one or more interpolated trends; decision 322, NO branch), health monitoring software 134 completes analyses of concurrently executing threads and/or enters an idle state until another request is received from one of client devices 110 (i.e., until performing operation 302) or application 132 is exited. If health monitoring software 134 determines that every threshold value is exceeded (decision 322, YES branch), health monitoring software 134 issues an alert that identifies the thread as an abnormally executed thread (operation 320). Logic that is analogous to the logic described by decisions 316 and 322 can be applied to embodiments in which, for at least one thread class, a single performance metric is associated with a plurality of trend templates (i.e., the trend templates are analogous to thread profiles in such embodiments).

It is not advantageous, however, to analyze certain types of threads (i.e., thread classes) via operations 300. One example of an unsuitable thread class is one that includes algorithm(s) with very complex logic (e.g., logic including a large number of conditional statements). As described herein, a thread class including such an algorithm would be associated with a large number of thread profiles. If the number of thread profiles is large enough, it is possible that every calculated trend may be valid under some condition. In some embodiments of the present invention, unsuitable thread classes are identified by comparing trend templates. In such embodiments, the distance between trend templates is calculated, as described herein. If health monitoring software 134 determines that the distance between any two trend templates (e.g., trend templates of respective thread profiles that are associated with the same performance metric) does not exceed a threshold, health monitoring software 134 determines that the thread class is unsuitable. If health monitoring software 134 analyzes a thread class that is determined to be unsuitable, health monitoring software 14 can withhold any alerts that would otherwise issue.

Additionally, it is not advantageous to analyze thread classes that frequently and/or prolongedly interact with computing devices outside of server 130. For example, it can be disadvantageous to analyze thread classes for which the time spent on synchronization with other threads or devices is significant compared to the time needed to perform any remaining activities. In a specific example of such a thread class, the exemplary thread class displays a message box and waits for a user (e.g., a user of one of client devices 110) to press a button. In general, the time required to render the message box in a popup window and close the popup window in response to a user interaction is not significant compared to the time spent waiting for the user interaction.

FIG. 3C depicts additional operations of operations 300, in accordance with various embodiments of the present invention. More specifically, FIG. 3C depicts a type of embodiment in which health monitoring software 134 does not include a predefined trend template for at least one measured performance metric in one or more thread classes. Instead, health monitoring software 134 calculates a trend template for each performance metric lacking a predefined trend template.

As depicted in FIG. 3C, health monitoring software 134 determines whether or not all trend templates are valid for the thread class of the executed thread (a first iteration of decision 324). In some embodiments, a trend template of a thread class is valid if it is based on a trend calculated from a specific number (i.e., a threshold count) of previously executed threads of the thread class. In other embodiments, a trend template of a thread class is valid if one or more statistical measures of a data set representing a plurality of previously executed threads (e.g., an average, a variance, a standard deviation, and/or a coefficient of determination) do not exceed respective threshold value(s). In addition, a trend template that does not exist is equivalent to an invalid trend template for the purposes of decision 324. If health monitoring software 134 determines that all trend template are valid for the thread class of the executed thread (first iteration of decision 324, YES branch), health monitoring software 134 compares the interpolated trend for each measured performance metric to the respective trend template(s) (operation 314). If health monitoring software 134 determines that not all trend templates are valid for the thread class of the executed thread (i.e., at least one trend template is not valid; first iteration of decision 324, NO branch), health monitoring software 134 generates, for each measured performance metric, a new template and/or modifies an existing trend template based on the executed thread (operation 326). If no trend template exists for a measured performance metric, the trend template generated in operation 326 is the trend interpolated in operation 310. If a trend template exists for a measured performance metric, data describing the executed thread is added to a data set that includes data that describes at least one previously executed thread, and a trend is calculated from the data set by interpolating consumption of the respective performance metric as a function of percent execution time, as described in greater detail with respect to FIG. 4.

In response to generating a new template or modifying an existing template for each measured performance metric, health monitoring software determines whether or not all trend templates are valid for the thread class of the executed thread (a second iteration of decision 324). In various embodiments, health monitoring software 134 can generate meta-data that identifies invalid trend templates based on the second iteration of decision 324 in order to reduce the time needed to perform operations associated with the first iteration of decision 324 with respect to a subsequently executed thread of the same thread class. Persons of ordinary skill in the art will understand that the first and second iterations of decision 324 are analogous, but based on different trend template(s). If health monitoring software 134 determines that not all of the trend templates are valid for the thread class of the executed thread (second iteration of decision 324, NO branch), health monitoring software 134 completes analyses of concurrently executing threads and/or enters an idle state until another request is received from one of client devices 110 (i.e., until performing operation 302) or application 132 is exited. If health monitoring software 134 determines that all of the trend templates are valid for the thread class of the executed thread (second iteration of decision 324, YES branch), health monitoring software 134 modifies the threshold value to reflect new trend template(s) and/or modifications to existing trend template(s) (operation 328). As described with respect to decision 318, the threshold value can be a distance between a baseline trend and a theoretical trend if a thread profile does not exist for the thread class of the executed thread or a composite threshold value if one or more thread profiles are associated with the thread class. The composite threshold value can be a sum of constituent threshold values associated with respective performance metrics or an average distance between baseline trends and respective, theoretical trends. Additionally, health monitoring software 134 associates any new trend template(s) and the respective threshold value(s) with the thread class of the executed thread (operation 330). If multiple thread profiles exist for a thread class, it is advantageous to implement application 132 and/or health monitoring software 134 such that health monitoring software 134 can determine which thread profile is associated with the executed thread in order to associate the trend template(s) and threshold value(s) with the appropriate thread profile. Health monitoring software 134 completes analyses of concurrently executing threads and/or enters an idle state until another request is received from one of client devices 110 (i.e., until performing operation 302) or application 132 is exited.

FIG. 3D depicts additional operations of operations 300, in accordance with various embodiments of the present invention. More specifically, FIG. 3D depicts a type of embodiment in which health monitoring software 134 can modify one or more predetermined or calculated trend templates. If health monitoring software 134 determines that a threshold value associated with (i) a single performance metric, (ii) a composite threshold value of a thread class that is associated with a single thread profile, or (iii) a composite threshold value of an identifiable thread profile does not exceed a threshold (decision 318, NO branch), health monitoring software 134 can modify the associated trend template(s) based on the executed thread (operation 332) and modify the associated threshold value based on the executed thread (operation 334), in order to optimize health monitoring software 134 over time. After modifying the one or more trend templates and the associated threshold value, health monitoring software 134 completes analyses of concurrently executing threads and/or enters an idle state until another request is received from one of client devices 110 (i.e., until performing operation 302) or application 132 is exited. Operation 332 and operation 334 are analogous to operation 326 and operation 328 respectively.

In some embodiments, an operation that is analogous to operation 334 is performed after health monitoring software 134 issues a specified number of alerts (i.e., performs operation 320 a specific number of times) in connection with a specific trend template or a specific trend profile. If, for example, application 132 is experiencing a progressive degradation of performance over time, one or more threshold values can be increased periodically in order to avoid flooding error logs with events.

FIG. 4 is a graph that depicts an example of a trend that is calculated from data describing consumption of a computing resource as a function of percent execution time, in accordance with an embodiment of the present invention. More specifically, FIG. 4 depicts interpolated trend 402, which is calculated from observed trend 404 via polynomial interpolation. Observed trend 404 is an example of a graph that results from performing operation 308 and is generated using the actual performance metric values measured in operation 306. As depicted in FIG. 4, plotting the measured values as a function of percent execution time produces noise that makes comparing the observed trend to an associated trend template difficult. To reduce the amount of noise in the trend, the measured values of the performance metric (i.e., observed trend 404) are interpolated to produce interpolated trend 402. In the embodiment depicted in FIG. 4, polynomial interpolation is used to produce interpolated trend 402. To produce interpolated trend 402, observed trend 404 is divided into a plurality of segments (e.g., three of four segments), as indicated by dividing lines 410, and maxima 406 and minima 408 are identified such that each segment includes a local maximum and a local minimum. Maxima 406 and minima 408 are points that are used to interpolate observed trend 404. In general, polynomials of degrees six through either are sufficient to accurately describe observed trend 404 via polynomial interpolation. Expression 1 is an example of an interpolation polynomial that can be used to calculate interpolated trend 402.

p(x)=aₙxⁿ+aₙ₋₁xⁿ⁻¹+ . . . +a₂x²+a₁x+a₀ Expression 1

In Expression 1, x is a percentage of the total execution time of the thread and constant a₀ represents background resource consumption and/or consumption of resources that are affect by the size of an input (i.e., an amount of data). Constant a₀ can be removed from interpolated trend 402 prior to calculating a distance between interpolated trend 402 and a trend template in order to compensate for background resource consumption and/or the size of an input during the execution of the thread. In various other embodiments, spline interpolation, trigonometric interpolation, interpolation via rational functions, interpolation via Gaussian processes, or another type of interpolation is used to produce interpolated trend 402. In some embodiments, constant a₀ is removed from the interpolated polynomial when generating trend template(s) from observed trends.

Person of ordinary skill in the art will understand that various methods to calculate the distance of two polynomial functions are known in the art. For example, the distance between two polynomial functions can be found via Expression 2.

$${\sum }_{1}^{100} abs ( f ( x ) - g ( x ) ) \qquad Expression 2$$

In Expression 2, f(x) is a function that describes interpolated trend 402, g(x) is a function that describes a trend template that is associated with the performance metric that is associated with interpolated trend 402, and x is a percentage of the total execution time of the thread. In some cases, the distance between interpolated trend 402 and a trend template can be relatively constant as a function of percent execution time (i.e., interpolated trend 402 and the trend template are shifted up or down relative to one another, but the behavior of the interpolated trend and the trend template are similar). This can occur due to the size of an input (i.e., an amount of data) associated with the request and/or background resource consumption on server 130. For some performance metrics, utilizing percent execution time compensates for the size of the input. While the total execution time for a large input is expected to be longer than the total execution time for a smaller input, it is assumed the interpolated trends will behave similarly for at least some performance metrics. To account for (i) background resource consumption and/or (ii) input size with respect to performance metrics for which the input size affects resource consumption, the distance between a function describing an interpolated trend and a function describing a trend template can be defined such that the distance is independent from background resource consumption (e.g., by removing constant a₀ from the polynomial describing the interpolated trend and/or trend template prior to calculating the distance).

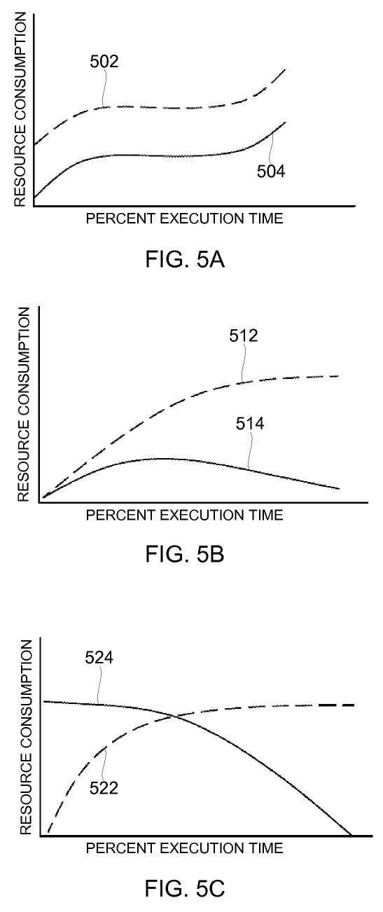

FIGS. 5A-5C depict examples of comparisons between an interpolated trend and a trend template, in accordance with an embodiment of the present disclosure. More specifically, each of FIGS. 5A-5C depicts (i) an interpolated trend in terms of consumption of a computing resource (i.e., consumption of a performance metric) as a function of percent execution time and (ii) a corresponding trend template.

FIG. 5A depicts interpolated trend 502 and trend template 504. As depicted in FIG. 5A, interpolated trend 502 and trend template 504 are offset but behave similarly. FIG. 5A is an example of a situation in which background resource consumption and/or the size of an input shifts an interpolated trend relative to a trend template. In general, the type of behavior depicted in FIG. 5A does not cause health monitoring software 134 to issue an alert that identifies the thread as an abnormally executed thread (i.e., perform operation 320). If, for example, the a₀ term is removed from an interpolated polynomial that describes interpolated trend 502, the distance between interpolated trend 502 and trend template 504 will be approximately zero in the example depicted in FIG. 5A.

FIG. 5B depicts interpolated trend 512 and trend template 514. As depicted in FIG. 5B, the resource consumption of interpolated trend 512 is higher than the resource consumption of trend template 514 over most of the total execution time of the thread, and the distance between interpolated trend 512 and trend template 514 increase over the execution time of the thread. In general, the type of behavior depicted in FIG. 5B causes health monitoring software 134 to issue an alert (i.e., perform operation 320). In some embodiments, a sum of distances between interpolated trend 512 and trend template 514 over the total execution time of the thread, as described with respect to Expression 2, that exceeds a threshold sum of distances (e.g., a threshold sum of distances for either a specific performance metric or a composite threshold sum of distances) causes health monitoring software 134 to issue and alert. In other embodiments, health monitoring software 134 issues an alert if, for any one percentage of the total execution time (e.g., for one or more integer values of x in Expression 2), a distance between interpolated trend 512 and trend template 514 exceeds a threshold (e.g., a threshold for either a specific performance metric or a composite threshold value). In yet other embodiments, health monitoring software 134 issues an alert if, over a range of percentages of the total execution time that is greater than or equal to a threshold range of percentages (e.g., a threshold count of sequential integer values of x in Expression 2,), the sum of distances between interpolated trend 512 and trend template 514 exceeds a threshold sum of distances (e.g., a threshold sum of distances for either a specific performance metric or a composite threshold sum of distances). In FIG. 5B, for example, a sum of distances in a range of percentages that is close to the origin may not exceed a threshold sum of distances, but health monitoring software 134 may issue an alert because a range of percentages that is further away from the origin exceeds the threshold sum of distances.

FIG. 5C depicts interpolated trend 522 and trend template 524. As depicted in FIG. 5C, the resource consumption of interpolated trend 522 increases over the total execution time of the thread, and the resource consumption of trend template 524 decreases over the total execution time of the thread (i.e., interpolated trend 522 and trend template 524 are inversely related). In general, the type of behavior depicted in FIG. 5C causes health monitoring software 134 to issue an alert (i.e., perform operation 320) despite the fact that (i) the average resource consumption of interpolated trend 522 and trend template 524 are substantially similar and (ii) the minimum and the maximum resource consumption values of interpolated trend 522 and trend template 524 are substantially similar. In some embodiments, a sum of distances between interpolated trend 522 and trend template 524 over the total execution time of the thread, as described with respect to Expression 2, that exceeds a threshold sum of distances (e.g., a threshold sum of distances for either a specific performance metric or a composite threshold sum of distances) causes health monitoring software 134 to issue and alert. In other embodiments, health monitoring software 134 issues an alert if, for any one percentage of the total execution time (e.g., for one or more integer values of x in Expression 2), a distance between interpolated trend 522 and trend template 524 exceeds a threshold (e.g., a threshold for either a specific performance metric or a composite threshold value). In yet other embodiments, health monitoring software 134 issues an alert if, over a range of percentages of the total execution time that is greater than or equal to a threshold range of percentages (e.g., a threshold count of sequential integer values of x in Expression 2), the sum of distances between interpolated trend 522 and trend template 524 exceeds a threshold sum of distances (e.g., a threshold sum of distances for either a specific performance metric or a composite threshold sum of distances). As demonstrated by embodiments described by Expression 2, health monitoring software 134 can compensate for changes in the signs of calculated distances (e.g., situations in which an interpolated trend and a trend template cross, as depicted in FIG. 5C) by, for example, determining the absolute value of the distance between an interpolated trend and a trend template.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The term(s) “Smalltalk” and the like may be subject to trademark rights in various jurisdictions throughout the world and are used here only in reference to the products or services properly denominated by the marks to the extent that such trademark rights may exist.

As used herein, a list of alternatives such as “at least one of A, B, and C” should be interpreted to mean “at least one A, at least one B, at least one C, or any combination of A, B, and C.”

Additionally, the phrase “based on” should be interpreted to mean “based, at least in part, on.”

The term “exemplary” means of or relating to an example and should not be construed to indicate that any particular embodiment is preferred relative to any other embodiment.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
detecting, by one or more computer processors, a thread that is executing, wherein the thread is spawned by a threaded application;
determining, by one or more computer processors, a thread class of the thread;
measuring, by one or more computer processors, a performance metric of the thread based on the thread class;
interpolating, by one or more computer processors, a trend that describes a consumption of the performance metric as a function of percent execution time; and
in response to determining, by one or more computer processors, that a threshold associated with the performance metric is exceeded based on a comparison of the trend to a trend template that is associated with the performance metric, issuing, by one or more computer processors, an alert identifying the thread as an abnormally executed thread in order to trigger a corrective action that improves a performance of a computing device that is configured to execute the threaded application.

2. The method of claim 1, wherein the trend template is a predefined template and the threshold is a predefined threshold.

3. The method of claim 1, wherein the trend template and the threshold are based on measurements of the performance metric in connection with one or more previously executed threads of the thread class.

4. The method of claim 1, wherein the threshold represent a distance between a function that describes the trend and function that describes the trend template.

5. The method of claim 1, wherein the performance metric is a measure of one of processor consumption, memory consumption, and bandwidth consumption.

6. The method of claim 1, wherein the trend that describes the consumption of the performance metric as a function of percent execution time is interpolated via polynomial interpolation to produce an interpolated function.

7. The method of claim 6, wherein the interpolated function is one of a sixth-degree polynomial, a seventh-degree polynomial, and an eighth-degree polynomial.

8. The method of claim 6, further comprising:
compensating, by one or more computer processors, for at least one of background resource consumption and a size of an input by eliminating a constant from the interpolated function.

9. A method comprising:
detecting, by one or more computer processors, a thread that is executing, wherein the thread is spawned by a threaded application;
determining, by one or more computer processors, a thread class of the thread;
measuring, by one or more computer processors, a plurality of performance metrics of the thread based on the thread class;
for each performance metric, interpolating, by one or more computer processors, a respective trend that describes a consumption of a respective performance metric as a function of percent execution time;
for each performance metric, comparing, by one or more computer processors, the respective trend to a respective trend template;
generating, by one or more computer processors, a composite value based on a plurality of trends and a plurality of trend templates; and
in response to determining, by one or more computer processors, that the composite value exceeds every composite threshold value of a plurality of composite threshold values, issuing, by one or more computer processors, an alert identifying the thread as an abnormally executed thread in order to trigger a corrective action that improves a performance a computing device that is configured to execute the threaded application.

10. The method of claim 9, wherein the thread class is associated with a plurality of thread profiles, and each thread profile is associated with a respective composite threshold value of the plurality of composite threshold values.

11. The method of claim 9, wherein each composite threshold value of the plurality of composite threshold values is a sum of constituent threshold values, each constituent threshold value representing a respective threshold distance between a baseline trend and a respective, theoretical trend that represents abnormal performance metric consumption.

12. The method of claim 9, wherein each composite threshold value of the plurality of composite threshold values is an average of constituent threshold values, each constituent threshold value representing a respective threshold distance between a baseline trend and a respective, theoretical trend that represents abnormal performance metric consumption.

13. A method comprising:
detecting, by one or more computer processors, a thread that is executing;
determining, by one or more computer processors, a thread class of the thread;
measuring, by one or more computer processors, a plurality of performance metrics of the thread based on the thread class;
for a first performance metric, calculating, by one or more computer processors, an interpolated trend that describes a consumption of the first performance metric as a function of percent execution time;
in response to determining, by one or more computer processors, that a first trend template that is associated with the first performance metric is invalid, modifying, by one or more computer processors, the first trend template based on the interpolated trend, wherein the first trend template is one of a plurality of trend templates that includes a second trend template, and wherein the second trend template is associated with a second performance metric of the plurality of performance metrics; and
in response to determining, by one or more computer processors, that each template of the plurality of trend templates is valid, modifying, by one or more computer processors, a composite threshold value based on the plurality of trends and the plurality of trend templates, wherein the composite threshold value is associated with the thread class.

14. The method of claim 13, wherein the first trend template is invalid when the first trend template is based on a count of previously executed threads that is less than a threshold count of previously executed threads.

15. The method of claim 13, wherein the first trend template is invalid when a statistical measure of first template exceeds a threshold value of the statistical measure, wherein the statistical measure is selected from a group of statistical measures consisting of an average, a variance, a standard deviation, and a coefficient of determination.

16. A computer program product for comprising:
a computer readable storage medium and program instructions stored on the computer readable storage medium, the program instructions comprising:
program instructions to detect a thread that is executing, wherein the thread is spawned by a threaded application;
program instructions to determine a thread class of the thread;
program instructions to measure a performance metric of the thread based on the thread class;
program instructions to interpolate a trend that describes a consumption of the performance metric as a function of percent execution time; and
program instructions to, in response to determining that a threshold associated with the performance metric is exceeded based on a comparison of the trend to a trend template that is associated with the performance metric, issue an alert identifying the thread as an abnormally executed thread in order to trigger a corrective action that improves a performance of a computing device that is configured to execute the threaded application.

17. The computer program product of claim 16, wherein the trend template is a predefined template and the threshold is a predefined threshold.

18. The computer program product of claim 16, wherein the trend template and the threshold are based on measurements of the performance metric in connection with one or more previously executed threads of the thread class.

19. The computer program product of claim 16, wherein the trend that describes the consumption of the performance metric as a function of percent execution time is interpolated via polynomial interpolation to produce an interpolated function that is one of a sixth-degree polynomial, a seventh-degree polynomial, and an eighth-degree polynomial.

20. The computer program product of claim 19, the program instructions further comprising:
program instructions to compensate for at least one of background resource consumption and a size of an input by eliminating a constant from the interpolated function.

21. A computer system comprising:
one or more computer processors;
one or more computer readable storage media;
program instructions stored on the one or more computer readable storage media for execution by at least one of the one or more processors, the program instructions comprising:
program instructions to detect a thread that is executing, wherein the thread is spawned by a threaded application;
program instructions to determine a thread class of the thread;
program instructions to measure a performance metric of the thread based on the thread class;
program instructions to interpolate a trend that describes a consumption of the performance metric as a function of percent execution time; and
program instructions to, in response to determining that a threshold associated with the performance metric is exceeded based on a comparison of the trend to a trend template that is associated with the performance metric, issue an alert identifying the thread as an abnormally executed thread in order to trigger a corrective action that improves a performance of the one or more computer processors, wherein the one or more computer processors are configured to execute the threaded application.

22. The computer system of claim 21, wherein the trend template is a predefined template and the threshold is a predefined threshold.

23. The computer system of claim 21, wherein the trend template and the threshold are based on measurements of the performance metric in connection with one or more previously executed threads of the thread class.

24. The computer system of claim 21, wherein the trend that describes the consumption of the performance metric as a function of percent execution time is interpolated via polynomial interpolation to produce an interpolated function that is one of a sixth-degree polynomial, a seventh-degree polynomial, and an eighth-degree polynomial.

25. The computer system of claim 24, the program instructions further comprising:
program instructions to compensate for at least one of background resource consumption and a size of an input by eliminating a constant from the interpolated function.
